(19) United States
(12) Patent Application Publication
(10) Pub. No.: US 2011/0071811 A1
(43) Pub. Date: Mar. 24, 2011

(54) USING EVENT CORRELATION AND SIMULATION IN AUTHORIZATION DECISIONS

(75) Inventors: David Gerard Kuehr-McLaren, Apex, NC (US); Govindaraj Sampathkumar, Cary, NC (US)

(73) Assignee: International Business Machines Corporation, Armonk, NY (US)

(21) Appl. No.: 12/562,496

(22) Filed: Sep. 18, 2009

(51) Int. Cl. G06G 7/62; G06F 21/00

(52) U.S. Cl. 703/13; 726/21

(57) ABSTRACT

Performance impacting operations (e.g., maintenance operations) performed on a system can, depending on a current state of the system, heavily impact the performance of the system, thus affecting a customer's experience with the system. Functionality can be implemented to control execution of the performance impacting operations based on simulating the impact of executing the operation. Depending on the current state of the system, execution of the maintenance operations can be allowed, deferred, and even blocked. This can ensure that the performance of the system is not compromised.

### BACKGROUND

Embodiments of the inventive subject matter generally relate to the field of access control, and more particularly, to techniques for using event correlation and simulation in authorization decisions.

In a heavily used e-commerce system, operations (e.g., maintenance operations) performed on the system can impact the performance of the system and affect the customer's experience in interacting with the system. Authorization systems typically operate based on static policies without considering the impact of the operations at a particular instant of time.

### SUMMARY

Embodiments include a method comprising determining that servicing a request may result in a secondary event. At least one of the secondary event and the servicing the request can affect performance that corresponds to the system. A performance metric associated with at least one of the secondary event and the servicing the request is identified. A current state of the system is determined based, at least in part, on a current usage of resources of the system. An estimated value of the performance metric is calculated based, in part, on the current state of the system, the secondary event, and the servicing the request. It is determined that the estimated value of the performance metric deviates from a threshold value of the performance metric. An indication that the servicing the request will result in a current value of the performance metric deviating from the threshold value is generated.

Another embodiment includes a method comprising determining that servicing a request for performing an operation on a system that can impact performance of the system will not result in a secondary event. A performance metric associated with the servicing the request is identified. An estimated value of the performance metric is calculated based, at least in part, on the state of the system, and the servicing the request. It is determined that the estimated value of the performance metric deviates from a threshold value of the performance metric. An indication that the servicing the request will result in a current value of the performance metric deviating from the threshold value of the performance metric is generated. The request is prevented from being serviced.

Another embodiment includes a computer program product for request authorization, where the computer program product comprises a computer usable medium comprising computer usable program code. The computer usable program code is configured to determine that servicing a request may result in a secondary event. At least one of the secondary event and the servicing the request can affect performance that corresponds to a system. The computer usable program code is also configured to identify a performance metric associated with at least one of the secondary event and the servicing the request, and determine a current state of the system based, at least in part, on a current usage of resources of the system. The computer usable program code is further configured to calculate an estimated value of the performance metric based, at least in part, on the current state of the system, the secondary event, and the servicing the request. The computer usable program code is configured to determine that the estimated value of the performance metric deviates from a threshold value of the performance metric and generate an indication that the servicing the request will result in a current value of the performance metric deviating from the threshold value.

Another embodiment includes an apparatus comprising a processor, a network interface coupled with the processor, and an authorization unit configured to control servicing a request based on simulating the request. The authorization unit comprises a look-ahead engine operable to determine that the servicing the request may result in a secondary event. At least one of the secondary event and the servicing the request can affect performance that corresponds to a system. The look-ahead engine is also operable to identify a performance metric associated with at least one of the secondary event and the servicing the request. The authorization unit also comprises a performance metric calculator operable to determine a current state of the system based, at least in part, on a current usage of resources of the system. The performance metric calculator is further operable to calculate an estimated value of the performance metric based, at least in part, on the current state of the system, the secondary event, and the servicing the request. The authorization unit further comprises a decision unit operable to determine that the estimated value of the performance metric deviates from a threshold value of the performance metric and generate an indication that the servicing the request will result in a current value of the performance metric deviating from the threshold value.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram illustrating authorization based on event correlation.

FIG. 2 is a flowchart depicting example operations for controlling access to a system based on simulation of the system requests.

FIG. 3 is a flow diagram illustrating example operations for analyzing the impact of the request on the system performance.

FIG. 4 is an example block diagram of a computer system configured for controlling servicing a request based on simulation of the request.

FIG. 5 is an example block diagram configured for simulation-based request authorization.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to a simulation-based authorization of maintenance operations on a computer network, operations for simulation-based authorization may be performed on individual servers, local computer systems, etc., for controlling resource manipulation and access to resources. In other instances, well-known instruction instances, protocols, structures, and techniques have not been shown in detail in order not to obfuscate the description.

System administrators are typically authorized to perform operations that can impact performance, such as system performance (e.g., maintenance operations) and service performance (e.g., performance as indicated in a service level agreement). In executing the performance impacting operations, a current state of the system is not taken into consideration to determine if the system's performance will be affected by the operations. For example, performing maintenance operations on a system that is being used heavily by customers can severely impact the performance of the system and the customers' interaction with the system. An authorization unit configured for controlling execution of the operations based on simulating the impact of executing the maintenance operations can ensure that the performance of the system is not compromised. On receiving a request to perform the operations, the authorization unit can calculate a score or a risk level, based on the current state of the system, associated with the operations and permit execution of the operations only if the score is within an allowable range of values. This can result in a proactive form of access control based on the current state of the system. Such a form of proactive access control can also help eliminate or reduce human error and malicious activity.

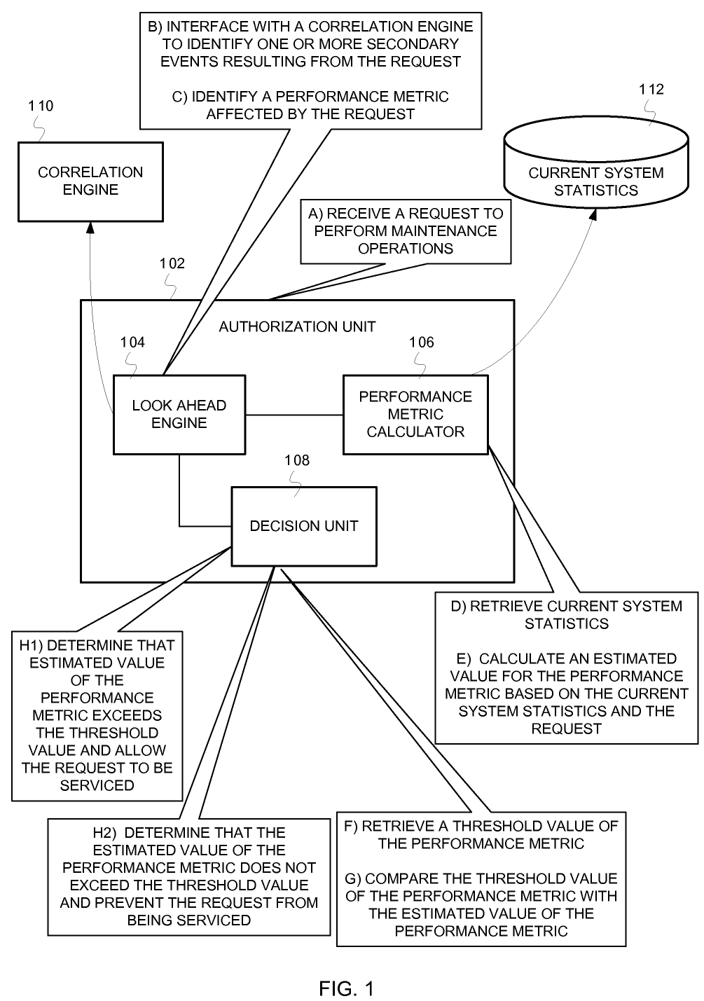

FIG. 1 is an example conceptual diagram illustrating authorization based on event correlation. FIG. 1 depicts an authorization unit 102. The authorization unit comprises a look-ahead engine 104, a performance metric calculator 106, and a decision unit 108. The look-ahead engine 104 is coupled with the performance metric calculator 106 and the decision unit 108. The look-ahead engine 104 performs operations for simulating the effect of a request based on inputs from a correlation engine 110. The performance metric calculator 106 calculates performance metric values based, in part, on the current state of the system retrieved from a current system statistics database 112.

At stage A, the authorization unit 102 receives a request to perform maintenance operations. It should be noted that the request to perform maintenance operations is an example. The authorization unit 102 can receive any suitable request. For example, the authorization unit 102 can receive a request to delete an application, launch an application (e.g., an application for backing up resources hosted by the server, etc.), delete information in a file (e.g., customer transaction information), etc. In some implementations, the decision unit 108 may intercept any incoming request to determine whether the request affects the performance of the system (e.g., CPU load, average response time, disk load, and other system operation performance metrics). In another implementation, the decision unit 108 may only analyze certain types of requests. For example, requests for deleting content on the system may be analyzed while requests for presenting content may not be analyzed. The decision unit 108 can transmit the request to the look-ahead engine 104 and prompt the look-ahead engine 104 to assess the request so that the decision unit 108 can determine an appropriate action (e.g., allow or block servicing the request, defer servicing the request for an interval of time, etc.) for the request. Although this example illustration refers to system performance, operations can impact more abstract performance (e.g., performance as represented by key performance indicators in a contract or service level agreement). For instance, a service provider can agree to meet/maintain a certain service level. Key performance indicator (KPI) values that represent the service level can be evaluated to determine the impact of an operation.

At stage B, the look-ahead engine 104 interfaces with a correlation engine 110 to identify one or more secondary events resulting from the request. The correlation engine 110 can indicate relationships between various events that can occur in the system. For example, the correlation engine 110 can indicate that rebooting a server results in the server being disconnected from the network which, in turn, results in applications on the server becoming unavailable to customers. In one implementation, a system administrator can program the correlation engine 110 by entering correlations between different events. In another implementation, the correlation engine 110 can have learning capabilities. During a test phase, various requests and events may be serviced and the correlation engine 110 may record the sequence in which the system services the events, correlations between the events, etc. The look-ahead engine 104 can determine a sequence of events that may result from servicing the request received at stage A. In another implementation, the look-ahead engine 104 can use a model of the system to simulate the request and identify the secondary events resulting from the request.

At stage C, the look-ahead engine 102 identifies a performance metric affected by the request. The look-ahead engine 102 can identify the performance metric affected by the request by identifying performance metrics affected by the execution of the secondary events. Referring to the server reboot example described at stage B, the look-ahead engine 102 can determine that a performance metric indicating an average response time between receiving an incoming request and servicing the incoming request (“response time”) is affected by the system reboot request. Other examples of performance metrics can include a percentage of incoming resource access requests that are dropped (i.e., not serviced) and a percentage of incoming resource access requests serviced in a specified time frame. In one implementation, one or more performance metrics affected by events may be pre-determined and stored (e.g., in a structure or file which the look-ahead engine may access).

At stage D, the performance metric calculator 106 retrieves information about the current state of the system from the current system statistics database 112. The current state of the system can be determined based on information in the system statistics database 112. For example, the information in the system statistics database 112 can be fed into a predictive model of the system to determine the current state of the system. In addition, statistics can represent the state of the system. The current state of the system may indicate a current load on the system, a current operating capacity, a number of servers currently in operation, available memory and CPU resources on each of the servers, etc. For example, the information about the current state of the system can indicate a number of incoming resource access requests (e.g., request for downloading a file, a customer request for accessing transaction information, a request to execute a monetary transaction, etc). The information about the current state of the system may also include a categorization of the incoming requests based on the type of requests and an average service time for each type of request.

At stage E, the performance metric calculator 106 calculates an estimated value for the performance metric based on the current state of the system and an assumption that the request has been serviced. The performance metric calculator 106 can use algorithms used to determine the state of the system to calculate an estimated value of the performance metric. For example, the performance metric calculator 106 can use a “response time algorithm” to compute the average response time over a certain interval of time. To calculate the estimated value of the response time performance metric, the performance metric calculator 106 can use the response time algorithm, input information about the current state of the system (e.g., a current number of customer requests received), input system statistics based on the assumption that the request is serviced (e.g., a number of servers online), and accordingly calculate the estimate value of the performance metric. The estimated value of the performance metric may be transmitted back to the decision unit 108 to enable the decision unit 108 to select an appropriate course of action for the request under consideration.

At stage F, the decision unit 108 retrieves threshold values for the performance metric. The decision unit 108 can identify the threshold values for the performance metric based on a service level agreement, financial risk scores, etc. For example, it may be indicated, in the service level agreement, that the response time for servicing a customer's request to access resources should not be less than 5 seconds. As another example, it may be indicated that the percentage of dropped requests should not exceed 2% of the total incoming requests over a two hour time period.

At stage G, the decision unit 108 compares the threshold value of the performance metric with the estimated value of the performance metric retrieved from the performance metric calculator. The decision unit 208 can determine an appropriate course of action (e.g., whether to allow, block, or defer servicing the request) based on determining whether the estimated value of the performance metric is an acceptable value of the performance metric.

At stage H1, the decision unit 108 determines that the estimated value of the performance metric does not exceed the threshold values of the performance metric. For example, the performance metric calculator may determine that given the current low rate of incoming customer requests, the response time if the server is rebooted will be 0.5 seconds. The decision unit 108 can compare the estimated value of the response time (i.e., 0.5 seconds) and the threshold value of the response value (e.g., 5 seconds). In another implementation, the decision unit 108 can determine that the expected value of the performance metric may lie within an optimum range of performance metric values. In another implementation, the expected value of the performance metric being above a threshold value may indicate that the expected value of the performance metric is in accordance with the threshold value. The decision unit 108 can direct an execution unit (or other hardware/software component configured to service the request) to service the request.

At stage H2, the decision unit 108 determines that the estimated value of the performance metric exceeds the threshold values of the performance metric. For example, the performance metric calculator 106 may determine that given the current high rate of incoming customer requests, the response time if the server is rebooted will be 10 seconds. The decision unit 108 can compare the estimated value of the response time (i.e., 10 seconds) and the threshold value of the response value (e.g., 5 seconds) and determine that the estimated value of the performance metric exceeds the threshold value of the performance metric. In another implementation, the decision unit 108 may determine that the estimated value of the performance metric exceeds the threshold values of the performance metric based on determining that the expected value of the performance metric lies outside an optimum range of performance metric values. In other implementations, the expected value of the performance metric being below a threshold value may indicate that the expected value of the performance metric does not comply with the threshold values.

In response to determining that the estimated value of the performance metric exceeds the threshold values of the performance metric, the decision unit 108 can prevent the request from being serviced. The decision unit 108 may direct the execution unit to defer servicing the request until the estimated value of the performance metric is within an acceptable range of values of the performance metric. However, in other implementations, the decision unit 108 may not prevent servicing the request. For example, servicing the request may be necessary even though servicing the request can result in a deviation from the expected system performance or a deviation from specified KPI values. Therefore, the decision unit 106 may be configured to notify the user or a system administrator of the consequences of servicing the request (e.g., servicing the request results in deviation from the expected system performance) but prompt the user for further action (e.g., authorize or block servicing the request).

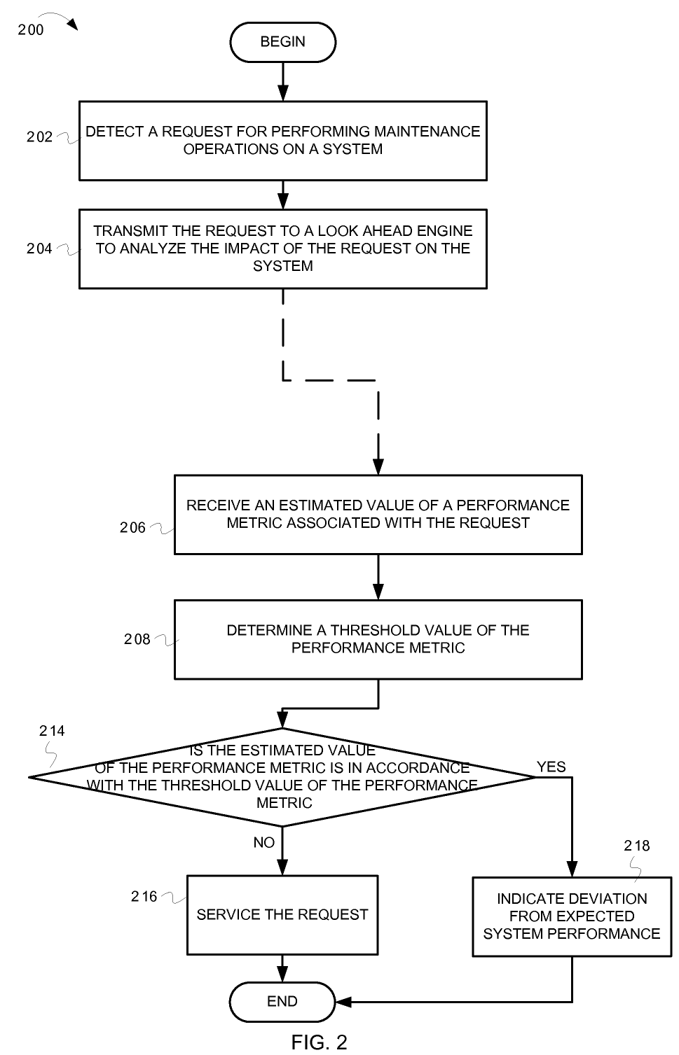

FIG. 2 is a flowchart depicting example operations for controlling access to a system based on simulation of the system request. Flow 200 begins at block 202.

A request for performing maintenance operations on a system is detected (block 202). For example, the decision unit 108 of FIG. 1 can detect an incoming request. The look-ahead engine 104 of FIG. 1 may also have an ability to detect and receive the request. The request may indicate modifying the system and/or system resources. As stated above, embodiments are not limited to maintenance and can involve operations that may affect performance, whether system performance or service performance. For example, a request for rebooting servers in the system may be detected. As another example, a request for deleting a resource (e.g., an application running on the server, a document on the server, etc.) may be received. As another example, a request to process batch transactions may be received. The flow continues at block 204.

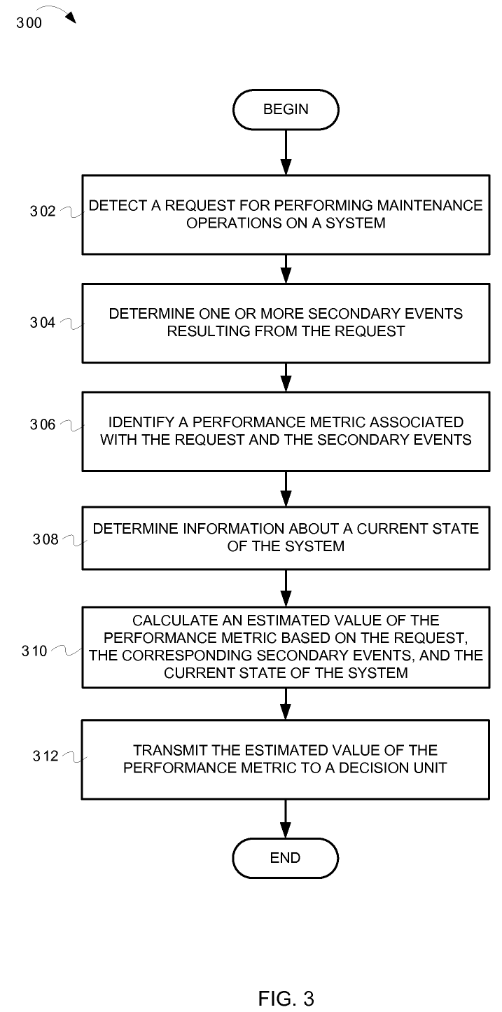

The request is transmitted to a look-ahead engine for analysis to determine the impact of the request on the performance of the system (block 204). In some implementations, the impact of the request on the KPI values specified for the system may be determined. One or more secondary events resulting from the request may be identified. For example, it may be determined that a request for deleting an application on a server results in customers not being able to access the application. As another example, it may be determined that rebooting a server in the system results in 1) the server going offline, 2) the customers not being able to access the server, 3) the customers not being able to access resources hosted by the server, etc. Performance metrics associated with the request and/or the secondary events may also be identified. The request may be simulated and an estimated value of the performance metric may be calculated based on simulating servicing the request. For example, in response to receiving the request for deleting an application on the server, the deletion of the application may be simulated. As a result of the simulation, it may be determined that deleting the application results in customers not being able to access the application, which in turn affects the response time for servicing requests for accessing the application. Operations for analyzing the impact of the request on the performance of the system are further described with reference to FIG. 3. The flow continues at block 206.

An estimated value of a performance metric associated with the request is received (block 206). The estimated value of the performance metric may be received by the decision unit 108 of FIG. 1 by the look-ahead engine 104. The dashed lines between blocks 204 and 206 represent the decision unit 108 waiting for a response (e.g., the estimated value of a performance metric associated with the request) from the look-ahead engine. The estimated value of the performance metric can be obtained based on analyzing the impact of the request on the system performance and/or an effect on the KPI values of the system. The estimated value of the performance metric may be calculated (based on operations described with reference to FIG. 3) based on the current state of the system and a simulation of executing the request. The flow continues at block 208.

A threshold value of the performance metric associated with the request is identified (block 208). The threshold value of the performance metric can indicate a maximum acceptable level of performance. The threshold value may be determined based on a service level agreement. For example, it may be indicated, in the service level agreement, that the response time for servicing a customer request should be no less than 5 seconds. As another example, it may be indicated that a percentage of dropped (e.g., not serviced) requests should not exceed 5% of the total requests received over a thirty minute interval. The threshold value of the performance metric may also be determined based on financial risk scores. The financial risk scores may indicate a level at which the financial risk, associated with a request, to an organization becomes unacceptable. The flow continues at block 210.

It is determined whether the estimated value of the performance metric is in accordance with the threshold value of the performance metric (block 210). In some implementations, it may be determined whether the estimated value of the performance metric is greater than or less than the threshold value. In other implementations, it may be determined whether the estimated value of the performance metric is within or outside a range of optimal performance metric values. If it is determined that the estimated value of the performance metric is in accordance with the threshold value of the performance metric, the flow continues at block 216. Otherwise, the flow continues at block 218.

The request is serviced (block 216). For example, servicing the request may be allowed if an estimated financial score associated with the request is less than the financial risk score for the performance metric. An execution unit or other hardware/software component, configured to service the request, may be directed to begin servicing the request. The execution unit may execute one or more operations for servicing the request. From block 216, the flow ends.

A deviation from expected system performance is indicated (block 218). In one implementation, servicing the request may also be blocked. For example, an execution unit may be directed to stop servicing the request, delete the request from an execution pipeline, etc. In another implementation, the servicing the request may be deferred indefinitely or until the expected value of the performance metric falls within acceptable range of values of the performance metric. In another implementation, the servicing the request may not be blocked. Instead, the user who initiated the request or the system administrator may be prompted to confirm that the request should be serviced. An indication that servicing the request will result in the system performance deviating from optimal system performance and/or a deviation from specified KPI values may also be presented. From block 218, the flow ends.

FIG. 3 is a flow diagram illustrating example operations for analyzing the impact of a request on system performance. Flow 300 begins at block 302.

A request for performing maintenance operations on a system is detected (block 302). The request may be generated in response to a system administrator or other user performing system maintenance operations. The request may also be generated in response to a scheduled maintenance operation such as server backup operations. Some examples of the request can include a server reboot request, a request for deleting an application on the server, a request processing batch transactions, a request for performing database indexing, and other operations that may impact system performance, customer experience, etc. The flow continues at block 304.

One or more secondary events resulting from servicing the request are determined (block 304). As described, the request may be initiated by a user/administrator. The operating system (or other software/hardware on a computer) can receive the request and perform operations to service the request. The secondary events can be operations performed by the system in response to the request. For example, the user may initiate a request to reboot a server. The operating system may receive the request to reboot the server and perform operations such as disconnecting the server from a communication network, shutting down the server, and restarting the server. The operations for disconnecting the server from the communication network, shutting down the server, and restarting the server may be determined as the secondary events. An event correlation engine may be used to determine a correlation between the detected request and the secondary events, which may affect the performance of the system. In some implementations, the secondary events that result in the system deviating from specified KPI values may be identified. For example, a request to reboot five of ten servers in the system may be received. The reboot request may be transmitted to the event correlation engine. The event correlation engine may indicate that rebooting the five of the ten servers in the system results in the five servers going offline, which in turn results in the resources hosted by the five severs being unavailable to customers. The flow continues at block 306.

A performance metric associated with at least one of the request and the secondary events is identified (block 306). The performance metric can define and quantify the performance of the system. For example, an average response time between receiving an incoming request and servicing the incoming request may be a performance metric. Another example of a performance metric may be an average time for retrieving and presenting resources (e.g., a time between the user entering user credentials and the user viewing transaction history on a web browser). The performance metric may be determined based on the key performance indicators. In the server reboot example described with reference to block 304, it may be determined that rebooting five of ten servers affects the average response time. In one implementation, the event correlation engine may determine the performance metric associated with the secondary events. In another implementation, an algorithm used to calculate current values of the performance metric might be analyzed to determine whether the request and the secondary events affect the performance metric. For example, an algorithm used to calculate the average response time might be analyzed to determine whether rebooting the servers (or the servers going offline) will affect the average response time. The flow continues at block 308.

Information about a current state of the system is determined (block 308). The information about the current state of the system can quantify a current performance of the system, a load on the system, a number of servers currently in operation, available memory and CPU resources on each of the servers in operation, etc. The information about the current state of the system may be determined every specified interval of time (e.g., every five minutes, every hour, etc.) or as required. The information about the current state of the system can describe a number of times a resource is accessed (e.g., a number of times a web page is viewed), a number of customers accessing a resource (e.g., downloading a file) over a given time period, etc. The current state of the system can also indicate a number of incoming customer requests (e.g., request for downloading a file, a customer request for accessing transaction information, a request to execute a monetary transaction, etc), a number of customer requests serviced per interval of time. The flow continues at block 310.

An estimated value of the performance metric is calculated based at least on the request, the secondary events associated with the request, and the information about the current state of the system (block 310). An algorithm or predictive model may be used for calculating the estimated value of the performance metric. For example, an algorithm for calculating an average response time as part of a preconfigured system check may be used to calculate the estimated value of the average response time while simulating servicing the server reboot request. To calculate the estimated value of the response time, the average response time algorithm may take input values such as a current rate of incoming customer requests and a number of servers that will be offline when the reboot request is serviced. The flow continues at block 312.

The estimated value of the performance metric is transmitted to a decision unit (block 312). The decision unit (e.g., the decision unit 108 of FIG. 1) can compare the estimated value of the performance metric with threshold values of the performance metric and accordingly allow, block, or defer servicing the request as described with reference to FIG. 2. From block 312, the flow ends

It should be noted that the operations described in the flow diagrams are examples meant to aid in understanding embodiments, and should not be used to limit embodiments or limit scope of the claims. Embodiments may perform additional operations, fewer operations, operations in a different order, operations in parallel, and some operations differently. For example, secondary events resulting from the request may not exist or may not be determined. In some implementations, a performance metric associated with the request may be determined irrespective of whether secondary events resulting from the request can be identified. In other implementations, servicing the request may be blocked if the secondary events resulting from the request and/or the performance metric associated with the request cannot be identified. Also, the operations described with reference to FIGS. 2-3 may be implemented across any suitable network (e.g., an intranet, an extranet, etc.) or on individual computer systems to enable access control based on simulating servicing the request and the impact of servicing the request on the system.

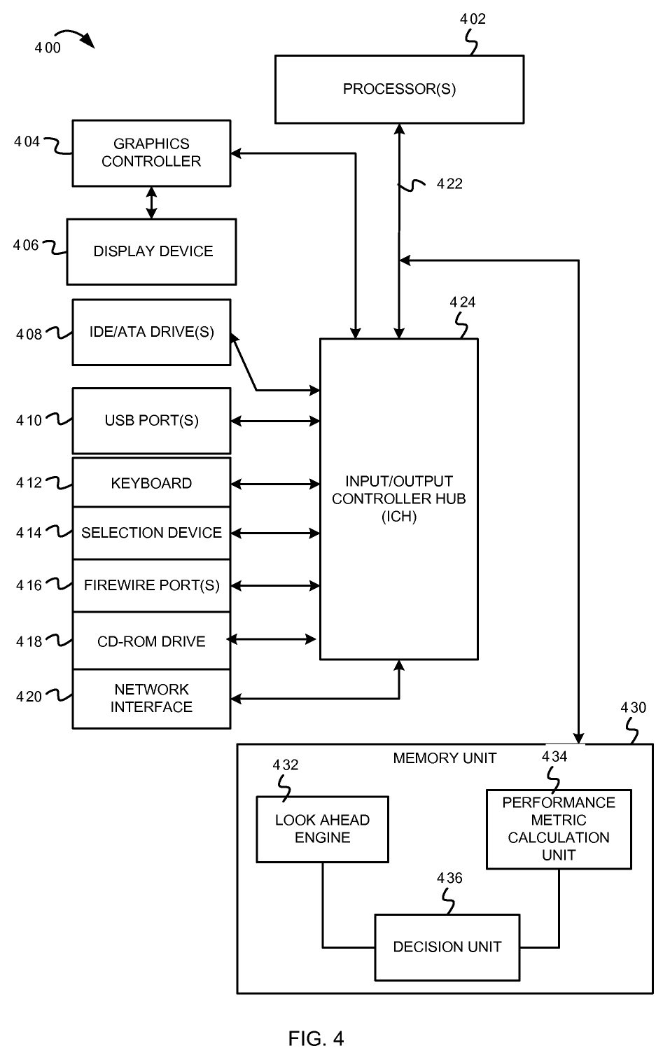

FIG. 4 is an example block diagram of a computer system 400 configured for controlling servicing a request based on simulation of the request. The computer system 400 includes a processor 402. The processor 402 is connected to an input/output controller hub 424 (ICH), also known as a south bridge, via a bus 422 (e.g., PCI, ISA, PCI-Express, HyperTransport, etc). A memory unit 430 interfaces with the processor 402 and the ICH 424. The main memory unit 430 can include any suitable random access memory (RAM), such as static RAM, dynamic RAM, synchronous dynamic RAM, extended data output RAM, etc.

The memory unit 430 embodies functionality to allow or block servicing a request to modify the state of the system based on a simulation of the impact of the request on the system performance and/or key performance indicators specified for the system. The memory unit 430 comprises a look-ahead engine 432, a performance metric calculation unit 434, and a decision unit 436. The decision unit 436 is coupled with the performance metric calculation unit 434 and the look-ahead engine 432. The decision unit 436 receives the request to modify the system. For example, the request may be to perform maintenance operations on the system such as rebooting a server in the system. As another example, the request may be for deleting an application on the server. The decision unit 436 can prompt the look-ahead engine 432 to analyze the performance of the system by simulating servicing the request. The look-ahead engine 432 can identify secondary events resulting from the request and performance metrics that may be affected by servicing the request. The look-ahead engine 432 also interfaces with the performance metric calculation unit 434 to obtain an estimated value of the performance metric. The decision unit 436 compares the estimated value of the performance metric with threshold values of the performance metric and determines whether the estimated value of the performance metric is within acceptable limits of the threshold values. The decision unit 436 can accordingly allow or block servicing the request.

The ICH 424 connects and controls peripheral devices. In FIG. 4, the ICH 424 is connected to IDE/ATA drives 408 (used to connect external storage devices) and to universal serial bus (USB) ports 410. The ICH 424 may also be connected to a keyboard 412, a selection device 414, firewire ports 416, CD-ROM drive 418, and a network interface 420. The ICH 424 can also be connected to a graphics controller 404. The graphics controller is connected to a display device 406 (e.g., monitor). In some embodiments, the computer system 400 can include additional devices and/or more than one of each component shown in FIG. 4 (e.g., video cards, audio cards, peripheral devices, etc.). For example, in some instances, the computer system 400 may include multiple processors, multiple cores, multiple external CPU's. In other instances, components may be integrated or subdivided.

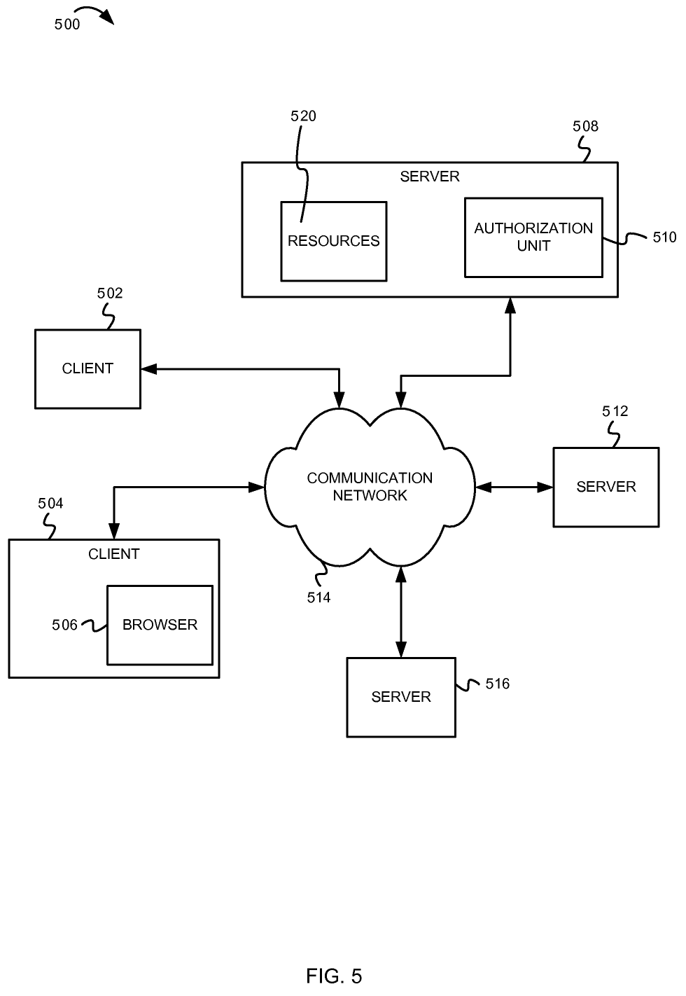

FIG. 5 is an example block diagram configured for simulation-based request authorization. The system 500 comprises servers 508, 512, and 516 and clients 502 and 504. The server 508 comprises resources 520 and an authorization unit 510. The other servers 512 and 516 comprise resources (e.g., applications, files, etc) but may or may not comprise an authorization unit. The authorization unit 510 on the server 508 can be configured to control servicing any request received by servers 508, 512, and 516 in the system 500. The clients 502 and 504 comprise a browser 506, which may be used to access and view resources 520 hosted by the servers 508, 512, and 516. It should be noted that in some implementations, the clients 502, 504, and 512 might view/modify the resources 518 by means of any suitable application.

The authorization unit 510 can allow or block execution of the request based on a simulation of the impact of the request on the system performance based on operations described with reference to FIGS. 1-4. In response to receiving a request (e.g., a request to access resources, a request to modify a current state of the system 500) from the client (e.g., the client 502), the authorization unit 510 can identify a performance metric that may be affected by servicing the request, simulate servicing the request, and calculate an estimated value of the performance metric. The authorization unit 510 can control (e.g., allow, block, defer) servicing the request based on comparing the estimated value of the performance metric with a threshold value of the performance metric.

In one implementation, the client 502 and 504 may be customer clients accessing resources 520 in an e-commerce system 500. In another implementation, the client (e.g., the client 504) may be used (e.g., by a system administrator) to perform maintenance operations on the system 500 or manipulate the resources 520.

The servers 508, 512, and 516 and the clients 502 and 504 communicate via a communication network 514. The communication network 514 can include any technology (e.g., Ethernet, IEEE 802.11n, SONET, etc) suitable for passing communication between the servers 508, 512, and 516 and the clients 502 and 504. Moreover, the communication network 514 can be part of other networks, such as cellular telephone networks, public-switched telephone networks (PSTN), cable television networks, etc. Additionally, the servers 508, 512, and 516 and the clients 502 and 504 can be any suitable devices capable of executing software in accordance with the embodiments described herein. The authorization unit 510 on the server 508 may be implemented as a chip, plug-in, code in memory, etc.

Embodiments may take the form of a hardware embodiment, a software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

While the embodiments are described with reference to various implementations and exploitations, it will be understood that these embodiments are illustrative and that the scope of the inventive subject matter is not limited to them. In general, techniques for using event correlation and simulation in authorization decisions as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining that servicing a request may result in a secondary event, wherein at least one of the secondary event and the servicing the request can affect performance that corresponds to a system;
identifying a performance metric associated with at least one of the secondary event and the servicing the request;
determining a current state of the system based, at least in part, on a current usage of resources of the system;
calculating an estimated value of the performance metric based, at least in part, on the current state of the system, the secondary event, and the servicing the request;
determining that the estimated value of the performance metric deviates from a threshold value of the performance metric; and
generating an indication that the servicing the request will result in a current value of the performance metric deviating from the threshold value.

2. The method of claim 1, wherein the calculating the estimated value of the performance metric comprises:
simulating the servicing the request based, at least in part, on the current state of the system; and
determining the estimated value of the performance metric based, at least in part, on said simulating the servicing the request.

3. The method of claim 1, wherein the performance that corresponds to the system comprises at least one of a performance of the system and a performance as represented by a key performance indicator value.

4. The method of claim 1, wherein the threshold value of the performance metric is determined based on at least one of a service level agreement and a financial risk score.

5. The method of claim 1, further comprising at least one of preventing the servicing the request, deferring the servicing the request, generating an alert indicating the current value of the performance metric deviating from the threshold value, and presenting a prompt requesting permission to service the request.

6. A method comprising:
determining that servicing a request for performing an operation on a system that can impact performance will not result in a secondary event;
identifying a performance metric associated with the servicing the request;
calculating an estimated value of the performance metric based, at least in part, on a state of the system, and the servicing the request;
determining that the estimated value of the performance metric deviates from a threshold value of the performance metric;
generating an indication that the servicing the request will result in a current value of the performance metric deviating from the threshold value of the performance metric; and
preventing the servicing the request.

7. The method of claim 6, wherein the state of the system indicates at least one of an average response time between receiving the request and the servicing the request, a number of incoming resource access requests, nature of the resource access requests, a percentage of the incoming resource access requests that are dropped, and a percentage of the incoming resource access requests serviced in a specified time interval.

8. The method of claim 6, further comprising:
determining that a second performance metric, which is associated with a second request for performing a second operation that can impact the performance, cannot be identified; and
preventing servicing the second request.

9. The method of claim 6, further comprising:
determining an inability to identify a secondary event resulting from a second request for performing a second operation that can impact the performance;
determining that a second performance metric associated with servicing the second request cannot be identified; and
preventing the servicing the second request.

10. The method of claim 6, further comprising:
determining, based on simulating servicing a second request for performing a second operation on the system, that the second request results in a second secondary event associated with the second request;
identifying a second performance metric associated with at least one of the simulating servicing the second request and the second secondary event;
determining a state of the system based, at least in part, on a current usage of resources of the system;
calculating an estimated value of the second performance metric based, at least in part, on the state of the system, the simulating servicing the second request, and the second secondary event;
determining that the estimated value of the second performance metric does not deviate from a threshold value of the second performance metric; and
allowing servicing the second request.

11. A computer program product for request authorization, the computer program product comprising:
a computer usable medium having computer usable program code embodied therewith, the computer usable program code configured to:
determine that servicing a request may result in a secondary event, wherein at least one of the secondary event and the servicing the request can affect performance that corresponds to a system;
identify a performance metric associated with at least one of the secondary event and the servicing the request;
determine a current state of the system based, at least in part, on a current usage of resources of the system;
calculate an estimated value of the performance metric based, at least in part, on the current state of the system, the secondary event, and the servicing the request;
determine that the estimated value of the performance metric deviates from a threshold value of the performance metric; and
generate an indication that the servicing the request will result in a current value of the performance metric deviating from the threshold value.

12. The computer program product of claim 11, wherein the computer usable program code configured to calculate the estimated value of the performance metric further comprises the computer usable program code configured to:
simulate the servicing the request based, at least in part, on the current state of the system; and
determine the estimated value of the performance metric based, at least in part, on the computer usable program code simulating the serving the request.

13. The computer program product of claim 11, wherein the performance that corresponds to the system comprises at least one of a performance of the system and a performance as represented by a key performance indicator value.

14. The computer program product of claim 11, wherein the computer usable program code is further configured to:
determine that servicing a second request for performing an operation on the system that can impact performance will not result in a secondary event;
identify a second performance metric associated with the servicing the second request;
calculate an estimated value of the second performance metric based, at least in part, on the current state of the system, and the servicing the second request;
determine that the estimated value of the second performance metric deviates from a threshold value of the second performance metric;
generate an indication that the servicing the second request will result in a current value of the second performance metric deviating from the threshold value of the second performance metric; and
preventing the servicing the second request.

15. The computer program product of claim 11, wherein the current state of the system indicates at least one of an average response time between receiving the request and the servicing the request, a number of incoming resource access requests, nature of the resource access requests, a percentage of the incoming resource access requests that are dropped, and a percentage of the incoming resource access requests serviced in a specified time interval.

16. The computer program product of claim 11, wherein the computer usable program code is configured to:
determine that a second performance metric, which is associated with a second request for performing a second operation that can impact the performance, cannot be identified; and
prevent servicing the second request.

17. The computer program product of claim 11, wherein the computer usable program code is configured to:
determine an inability to identify a secondary event resulting from a second request for performing a second operation that can impact the performance;
determine that a second performance metric associated with servicing the second request cannot be identified; and
prevent the servicing the second request.

18. An apparatus comprising:
a processor;
a network interface coupled with the processor;
an authorization unit configured to control servicing a request based on simulating the request, the authorization unit comprising:
a look-ahead engine operable to:
determine that the servicing the request may result in a secondary event, wherein at least one of the secondary event and servicing the request can affect performance that corresponds to a system;
identify a performance metric associated with at least one of the secondary event and the servicing the request;
a performance metric calculator operable to:
determine a current state of the system based, at least in part, on a current usage of resources of the system;
calculate an estimated value of the performance metric based, at least in part, on the current state of the system, the secondary event, and the servicing the request;
a decision unit operable to:
determine that the estimated value of the performance metric deviates from a threshold value of the performance metric; and
generate an indication that the servicing the request will result in a current value of the performance metric deviating from the threshold value.

19. The apparatus of claim 18, further comprising:
the look-ahead engine operable to:
determine, based on simulating servicing a second request for performing a second operation on the system, that the second request results in a second secondary event, wherein at least one of the second secondary event and servicing the second request and can affect the performance that corresponds to the system;
identify a second performance metric associated with at least one of the second secondary event and the simulating the servicing the second request;
the performance metric calculator operable to:
determine a state of the system based, in part, on a current usage of the resources of the system;
calculate an estimated value of the second performance metric based, at least in part, on the state of the system, the second secondary event, and the simulating the servicing second request;
the decision unit operable to:
determine that the estimated value of the second performance metric does not deviate from a threshold value of the second performance metric; and
allow servicing the second request.

20. The apparatus of claim 18, wherein the authorization unit comprises one or more machine-readable media.
